(19) United States
(12) Patent Application Publication
(10) Pub. No.: US 2008/0190169 A1
(43) Pub. Date: Aug. 14, 2008

(54) Substrate having one or more grooved surfaces to suppress destructive acoustic interference and a method of making such a substrate

(75) Inventors: Robert G. Naum, Pittsford, NY (US); Zaegyoo Hah, Rochester, NY (US)

Correspondence Address: PATRICIA M. COSTANZO;PATS PENDING, P.O. BOX 101, ELMA, NY, 14059, US

(73) Assignee: Applied Coatings, Rochester, NY (US)

(21) Appl. No.: 11/707,183

(22) Filed: Feb. 14, 2007

(51) Int. Cl. G01N 29/30

(52) U.S. Cl. 73/1.82

(57) ABSTRACT

An ultrasound test object, i.e., a phantom, for the calibration of the imaging fidelity of acoustical imagining equipment comprises a substrate with a surface that is comprised of grooves having at least one reflecting surface with at least one scattering test target disposed at a desired distance from the reflecting surface. The reflecting surface is at an angle to the direction of propagation of beamed acoustical energy where the angle is predetermined for directionally controlled scattering of pulsed acoustical waves away from the surface thereby suppressing destructive interference between waves not impinging on the substrate and substrate-surface-reflected waves, thus increasing the field magnitude of echoed waves, thereby providing a phantom offering high resolution, complexity, and precision. A method for testing the performance of acoustical testing equipment is also taught. Reflection surfaces may be planar of curved and scatters may be randomly positioned on the reflecting surface as individual scatterers.

### STATEMENT REGARDING FEDERALLY SPONSORED RESEARCH OR DEVELOPMENT

This invention was made with government support under SBIR Phase II Grant No. 9 R44 EB000793-02A1 awarded by the National Institute of Health, National Institute of Biomedical and Bioengineering. The National Institute of Health, National Institute of Biomedical and Bioengineering and the government has certain rights in the invention.

### CROSS-REFERENCE TO RELATED APPLICATIONS

Not Applicable

### REFERENCE TO SEQUENCE LISTING, A TABLE OR A COMPUTER PROGRAM LISTING COMPACT DISK APPENDIX

Not Applicable

### BACKGROUND

The present invention relates generally to testing the performance of ultrasonic imaging systems and, more particularly, to means and methods for testing, measuring, and assessing the performance of ultrasonic imaging systems by using a substrate having at least one grooved surface that comprises a set of substantially parallel grooves, with at least one of the grooves having a reflecting surface which surfaces are at an angle to the direction of propagation of pulsed acoustical waves, positioned on the reflecting surfaces are test target scatterers that provide for a reduction or elimination of destructive interference between reflected and non-reflected pulsed acoustical waves, thus increasing the echo field magnitude.

The background information discussed below is presented to better illustrate the novelty and usefulness of the present invention. This background information is not admitted prior art.

To test the accuracy of ultrasonic imaging systems, test objects that mimic the acoustic characteristics of organic soft tissue are used. Test object assemblies, referred to as “phantoms,” are designed to exhibit the required speed of and attenuation responses to sound waves over a desired frequency range of interest and to maintain these responses stable over time and with changes in temperature.

Traditionally, phantoms comprise test target scatterers imbedded in tissue mimicking mediums, such as gels. Targets, traditionally, including threads, rods, spheres, cones, and thin nylon wires, although other targets such as simulated cysts may be present, are positioned at defined locations within the tissue mimicking material. These traditional phantom targets, however, have not been shown to produce detailed, high resolution, echo patterns required for evaluation of ultrasonic imaging systems. Presently, the industry relies on a mathematical representation of the system to characterize the performance of the represented imaging system. The mathematical algorithm that is used to analyze the data is known as the modulation transfer function (MTF).

MTF, also referred to as the “contrast transfer function”, provides a mathematical description of the three-dimensional spatial resolution of high contrast adjacent objects as a function of their separation distance and is used to evaluate the resolving capabilities of different imaging systems. MTF's ability to quantify small changes in contrast, as a function of object separation, provides an effective tool for the evaluation of ultrasonic systems. Generally, such separations are given in terms of spatial frequency, which is the inverse of distance. To resolve targets with higher spatial frequency components an imaging system is required to have better MTF.

Preliminary attempts to produce phantoms that could offer the detailed, high resolution test patterns required for use with MTF included producing patterns of acoustical scatterers on thin-films. It was thought that these acoustical scatterers could be precisely placed on the surface of the film so that the test targets could be used, not only in conjunction with standard performance evaluation methods, such as MTF, but also with aliasing, and spatial frequency response, and also with devices that would augment and enhance the capabilities and range of application of these methods. To date, however, producing high-resolution echoes from such systems has proved disappointing.

Early efforts used conventional printing techniques to imprint test patterns on thin-films. The many techniques for forming scatterers on a film substrate at a precise location include electrostatic or xerographic printing, lithography, sputtering, vacuum deposition and etching. The scatterers so produced were of sub-resolvable size, which is less than the wavelength of the ultrasonic wave, so that the ultrasound system could only detect their presence or absence, that is, the system could not detect any variability of the exact number and exact position of the individual scatterers. The individual scatterers were referred to as “digital” (either on or off, there or not there) in nature. The precise placement of these digital scatterers was hoped to create regions of controllable echogenicity based on their number per unit area and their arrangement relative to each other, similar in concept to a half-tone printing process. These patterns of regions can be analyzed with the same computer algorithms as used in electro-optical imaging systems, thus, facilitating the measurement of the imaging criteria, such as the modulation transfer function (as introduced above) which is defined as the normalized ratio of the measured intensity modulation of an image relative to the known intensity modulation of the originating object as a function of spatial frequency.

It has been found, however, that this technology suffers from several problems. One problem involves the difficulties encountered in scanning and capturing such patterns on the substrate. Also, the echoes generated from the sub-resolvable patterns of scatterers have generally been too weak. Weak echoes require higher amplification, but increasing the amplification results in images with reduced contrast.

These problems increase when the substrate is embedded in an attenuating medium, such as tissue mimicking material with more than 0.3 dB/cm/MHz of attenuation slope. In such a case, the echoes (sound waves) are obscured by the attenuation effect of the surrounding medium as they travel from the transducer to the target and back from the target to the transducer. Adding to the problem of attenuation, in presently available systems, is the problem presented by the phenomenon of destructive interference of the pulsed acoustic waves near the substrate.

To improve the echogenicity of the scatterers, the size of the scatterers can be increased, but this does not solve the problem because as the size of the scatterers increase, the number of scatterers per unit area decrease, thereby disrupting the halftone pattern.

When flexible substrates, such as plastic or rubber sheets, were tried, other problems were encountered, mainly caused by the loss of surface planarity. The flexibility of these materials gives them a propensity to bend and/or to form ripples causing artifacts to appear on Images obtained from patterns on flexible substrates.

In fact, in order to eliminate, or at least to reduce, the above discussed problems associated with testing and evaluating ultrasonic imaging means, it is clear that there remains an urgent need for the development of a method and means that will produce echoes having the high resolution required for precise data analysis.

### SUMMARY

The present invention satisfies the current unmet need for a method for testing and measuring the performance of ultrasonic imaging systems, also known as echography systems, and for a means, i.e., phantoms that offer various geometrically-shaped patterns of test targets fixed onto substrate reflecting surfaces that have been modified morphologically providing for a greatly reduced effect of destructive interference of the incoming acoustical waves. The method and means, according to the principles of the invention as described herein, enables the assessment of the performance of the ultrasonic imaging system in terms of criteria that modern imaging science has recognized as necessary or desirable for such assessment including the modulation transfer function, aliasing, and spatial frequency response.

The above advantages are made possible by providing for a phantom that provides for testing the performance of acoustical imaging systems, where the phantom comprises:
at least one substrate having at least one grooved surface, the grooved surface comprising a set of substantially parallel grooves; with at least one of the grooves having at least one reflecting surface where the reflecting surfaces provide for directionally controlled reflection of acoustical waves that impinge on the reflecting surfaces providing for reducing destructive interference between pulsed acoustical waves impinging on the reflecting surface and pulsed acoustical non-impinging waves.

The phantom further comprising wherein at least one of the grooves comprises at least two reflecting surfaces.

In a preferred embodiment, the phantom further comprises wherein at least one of the grooves comprises at least one planar reflecting, where another preferred embodiment comprises at least one curved surface having an infinite number of reflecting surfaces, and wherein another favored embodiment comprises a substrate giving at least two grooved surfaces.

The phantom further comprising at least one test target scatterer disposed on at least one of the reflecting surfaces providing for a reduction or elimination of destructive interference between reflected and non-reflected pulsed acoustical waves, thus increasing the echo field magnitude.

The phantom further comprising wherein the grooves of the grooved surface are oriented substantially parallel to the direction of acoustical wave propagation.

In yet another embodiment the grooves are oriented at an angle to the direction of acoustical wave propagation.

The substrate may be a film or a sheet or a plate, wherein the substrate may be made from a material selected from a group consisting of a plastic, a metal, a glass, a ceramic, a rubber, and a composite material.

It is contemplated that the substrate is embedded in a wave propagating medium.

Another favored embodiment of the present invention provides for a substrate for testing the performance of acoustical imaging systems, comprising: a substrate having at least one grooved surface, the grooved surface comprising a set of substantially parallel grooves;
at least one of the grooves having at least one reflecting surface, where the reflecting surface provides for directionally controlled reflection of acoustical waves impinging on the reflecting surface providing for reducing destructive interference of pulsed acoustical waves impinging on the reflecting surface and non-impinging pulsed acoustical waves.

This preferred embodiment further comprises wherein at least one of the grooves comprises at least two reflecting surfaces.

Another preferred embodiment further comprises at least one of the grooves having at least one planar reflecting surface or at least one curved surface having an infinite number of reflecting points of surface.

These embodiments contemplate the substrate further comprising at least one test target scatterer disposed on at least one of the reflecting surfaces.

It is further contemplated that the substrate comprises wherein the grooves are oriented substantially parallel to a direction of acoustical wave propagation and that in further preferred embodiments, the grooves are oriented at an angle to the direction of acoustical wave propagation.

The substrate may comprise a film or a sheet or a plate wherein the substrate is made from a plastic, a metal, a glass, a ceramic, a rubber, and a composite material.

The substrate further comprising being embedded in a wave propagating medium.

Yet another favored embodiment provides for a method of testing the performance of acoustical imaging systems, comprising:
providing at least one substrate having at least one grooved surface comprising a set of substantially parallel grooves;
providing for at least one of the grooves to comprise at least one reflecting surface, providing at least one test target scatterer disposed on at least one of the reflecting surfaces.
embedding the substrate in a wave propagating medium,
pulsing energy in the form of acoustic waves through the wave propagating medium toward the test target scatterers, the test target scatterers providing for directionally controlled scattering of pulsed acoustic waves impinging on the scatterers providing for reduced destructive interference of pulsed acoustic waves impinging on the reflecting surface and non-impinging pulsed acoustic waves providing for an increased field magnitude of echoed waves.

Still other benefits and advantages of this invention will become apparent to those skilled in the art upon reading and understanding the following detailed specification and related drawings.

### BRIEF DESCRIPTION OF THE DRAWINGS

In order that these and other objects, features, and advantages of the present invention may be more fully comprehended and appreciated, the invention will now be described, by way of example, by reference to specific embodiments thereof as illustrated in appended drawings, wherein like reference characters indicate like parts throughout the several figures. It should be understood that these drawings only depict preferred embodiments of the present invention and are not therefore to be considered limiting in scope, and accordingly, the invention now will be described and explained with additional specificity and detail through the use of the accompanying drawings, in which:

FIG. 1 is a perspective view illustrating in general, presently known systems that may be used to test and measure the performance of acoustical imaging systems, whereas such a system utilizes an acoustic transducer and a thin-film phantom having a substrate with embedded test pattern scatterers.

FIG. 2 is a side plan view of a system, such as that illustrated in FIG. 1, to illustrate, in general, some of the problems that are inherent in the use of presently known thin-film phantoms.

FIG. 3 is a side plan view of a presently known system that may be used to test and measure the performance of acoustical imaging systems, utilizing a flexible substrate to illustrate the bends or ripples that can occur in such a substrate.

FIG. 4 is a side plan view of a known system comprising a substrate (4) and a transducer (2) emitting pulsed acoustic energy toward the substrate to illustrate some of the physical phenomena that are involved when using, for example, thin-film phantoms to test and measure the performance of ultrasonic imaging systems.

FIG. 5 is a side plan view of a sound wave interacting with a substrate surface to illustrate wave reflection/transmission when the substrate has lower speed of sound than surrounding medium.

FIG. 6 is a perspective view of a diagrammatic illustration of a substrate with modified morphology, i.e., having opposing grooved surfaces, as an example of the principles of the present invention.

FIG. 7 is a graphical illustration of the field intensity on a relative scale as a function of the distance from a thin-film substrate having a modified, i.e., grooved substrate surface.

FIG. 8 is a series of cross-sectional views illustrating, as example, a variety of modifications that may be used to adapt one or more substrate surfaces according to the principles of the present invention.

### A LIST OF THE REFERENCE NUMBERS AND PARTS OF THE INVENTION TO WHICH NUMBERS REFER

1 A transducer for generating pulses of acoustical energy and for receiving echoes 5 of the sound waves.
2 Discrete elements of transducer 1.
3 Patterns of scatterers on substrate 4.
4 Substrate imprinted with pattern of scatterers 3.
5a Pulsed sound waves emanating from transducer 1.
5b Echoes of the sound waves 5a scattered by scatterers 3 disposed on substrate 4, the echoes to be received by 1.
6 Tissue mimicking material in which substrate 4 is embedded.
7 Wave front.
8 Scatterer on the substrate 4.
9 Echoes from the scatterer 8.
10 Deformed wave front inside substrate 4.
11 Bends of deformed flexible substrate 13.
12 Ripples of deformed flexible substrate 13.
13 Flexible substrate.
14 Point on a transducer element 2.
15 Unobstructed path of sound wave pulsed from transducer 2.
16 Deflected path of sound wave pulsed from transducer 2.
17 Angle of incidence.
18 One section of transducer element 2.
19 Another section of transducer 2.
20 Section of transducer 2 directly over substrate 4.
21 Another deflected path of sound wave pulse.
22 Another point on a transducer element 2.
23 Incoming acoustic pulse wave.
24 A point of reflection.
25 Direct path of sound wave emitted from the transducer element 2.
26 Path of a sound pulse wave reflected off the modified, i.e., grooved, substrate surface 27 that will not contact target scatterer 8.
27 Modified surfaces of a substrate, herein modified in the form of grooves.
28 Field intensity when no substrate is present.
29 Field intensity with substrate without surface modification.
30 Field intensity with substrate with surface modification.

### DEFINITIONS

Angle of incidence, as used herein, is the angle between a beam incident on a surface and the line perpendicular to the surface at the point of incidence, called the normal.

Angle of refraction, as used herein, refers to the angle a wave makes to the normal when a wave passes from one medium into another.

Critical angle, as used herein, is the angle of incidence at which an incident sound wave is first totally internally reflected.

Echo, as used herein, refers to a sound wave that is being reflected back to its source, such as the transducer used in the illustrations, in sufficient strength and with a sufficient lag time to be separately distinguished from other wave pulses. When a surface reflects sound it partially absorbs and partially reflects the energy. As the process is repeated the echo becomes weaker and weaker and eventually ceases.

Echogenic, as used herein, refers to structures that reflect high-frequency sound waves that can be imaged by ultrasound techniques.

Modulation Transfer Function (MTF), as used herein, refers to one of the most commonly used quality metrics of any Linear Shift Invariant imaging system that is used to successfully characterize imaging systems. However, in order for a quantitative measure to be performed, a test target must first be developed. A direct measurement of the MTF normally requires sinusoidal test patterns of various spatial frequencies. In the case of ultrasound this implies that patterns should have an acoustic impedance mismatch that varies in a sinusoidal fashion. This has been very difficult to achieve.

Phantoms, as used herein, refer to structures that contain one or more materials that simulate a body of tissue in its interaction with ultrasound and are used to mimic ultrasonic interactions in the human body. Materials commonly used include agar, Zerdine, urethanes and epoxies. Tissue mimicking materials should match the speed, attenuation and scatter characteristics of soft tissue over the frequency range of interest and be stable with time and temperature. Phantoms can be used for different purposes such as quality assurance testing, research, and development of ultrasound equipment and methods. The phantoms described herein include a substrate that has been morphologically modified, such as by being grooved, and a medium in which the substrate is suspended.

Reflection of sound waves, as used herein, refers to the return of all or part of a sound wave when it encounters the boundary between two media. The most important rule of reflection is that the angle of incidence is equal to the angle of reflection. When a wave strikes a non-perpendicular surface/interface, i.e. striking a flat interface at a given angle of incidence the incident beam is reflected away from the incident surface at an angle equal to the angle of incidence, away from the normal line, thus the departure angle, or angle of reflection, is equal to the angle of incidence. However, reflection of sound waves off of surfaces is affected by the shape of the surface. As just mentioned, flat or planar surfaces reflect sound waves in such a way that the angle at which the wave approaches the surface equals the angle at which the wave leaves the surface. Reflection of sound waves off of curved surfaces leads to a more interesting phenomenon. Curved surfaces with a parabolic shape focus sound waves to a point. At that point, the sound is amplified. The amount of reflection is also dependent upon the dissimilarity of the physical properties of the two mediums. However, for an incident beam greater than a critical angle complete reflection will occur.

Reflection coefficient, as used herein, refers to the mathematical expression that is used to quantify reflection. The reflection coefficient is defined as the ratio of the reflected and incident wave amplitudes. The value of the reflection coefficient relates to the magnitude of reflection from the interface between two media with different physical properties.

Refraction, as used herein, refers to a change in the direction of waves as they pass from one medium to another. Refraction, or bending of the path of the waves, is accompanied by a change in speed and wavelength of the waves. So if the medium (and its properties) are changed, the velocity of the waves is also changed. Thus, waves passing from one medium to another will undergo refraction.

Scattering, as used herein, is a general physical process whereby some forms of radiation, such as sound, are forced to deviate from a straight trajectory by one or more localized non-uniformities in the medium through which it passes. In conventional use, this also includes deviation of reflected radiation from the angle predicted by the law of reflection. Reflections that undergo scattering are often called diffuse reflections and unscattered reflections are called specular (mirror-like) reflections. The effects of such features, i.e., scatterers, on the path of almost any type of propagating wave or moving particle can be described in the framework of scattering theory. When radiation is only scattered by one localized scattering center, this is called single scattering. It is very common that scattering centers are grouped together, and in those cases the radiation may scatter many times, which is known as multiple scattering. Some areas where scattering and scattering theory are significant include medical ultrasound, radar sensing, semiconductor wafer inspection, polymerization process monitoring, acoustic tiling, free-space communications, and computer-generated imagery.

Scatterers or scattering centers, as used herein, refer to the types of non-uniformities that can cause scattering. The various types of scatterers in use are too numerous to list, but a small sample includes particles, bubbles, droplets, density fluctuations in fluids, defects in crystalline solids, surface roughness, cells in organisms, and textile fibers in clothing.

Sound wave, as used herein, refers to waves that are created by the transfer of energy from a vibrating object to a different medium through which the wave is propagated from one location to another. Sound waves, in order to transport their energy from one location to another in a given medium, rely on particle interaction of the medium through which they are propagated. When a sound wave encounters a medium having properties different from the medium through which the sound wave had been traveling, the sound wave may reflect off the second medium, diffract around the medium, and/or be transmitted (accompanied by refraction) through the medium. Reflection of sound waves off of surfaces can lead to the phenomenon of an echo.

Substrate, as used herein, refers to any material onto which images, including the scatterers used in the present invention, may be printed or positioned and is often selected from the group consisting of one of a plastic, a metal, a glass, a ceramic, a rubber, and a composite material. Other materials include, although are not limited to, thin films, foils, rubber or the like, textiles, fabrics, plastics, any variety of paper (lightweight, heavyweight, coated, uncoated, paperboard, cardboard, etc.) or parchment. Typically it is the end use of the printed product that is the main factor used to determine the material from which the substrate is made. The substrate can take the form of a film, sheet, or a plate.

Thin-films, are sometimes referred to as “phantoms” or “calibration targets”, and as used herein, refer to any type of thin-film substrate that is capable of having patterns of sub-resolvable, scattering, test pattern sites precisely positioned on, near, or within, the thin-film imaging plane for their use as high-resolution test objects for the evaluation of the imaging fidelity of ultrasonic imaging systems.

Tissue mimicking materials, as used herein, refers to any material that mimics or simulates the acoustic properties of soft tissue the composition of which may include but is not limited to gels, water, aqueous solutions, and any other tissue mimicking material that meets the acoustic property requirements.

Transducer, as used herein, refers to any device that converts input energy into output energy, wherein the output energy has a known relationship to the input energy but differs in kind. Originally, the term referred to a device that converted mechanical stimuli into electrical output, but has been broadened to include devices that sense all forms of stimuli, such as heat, radiation, sound, strain, vibration, pressure, and, of importance herein, electrical energy. More particularly, an electromechanical transducer, as used herein, refers to any type of device that either converts an electrical signal into sound waves (as in a loudspeaker) or converts a sound wave into an electrical signal (as in the microphone), for example. Many of the transducers used in everyday life operate in both directions, such as the speakerphone on certain intercoms. The electrical transducers discussed herein are generally referred to simply as transducers and are the type that convert electrical energy to sound wave energy, well-known examples of this type of transducer include piezoelectric quartz crystals, piezoelectric ceramics, and ceramic/polymer composites.

Ultrasound is defined herein as sound having a frequency greater than the upper limit of human hearing.

It should be understood that the drawings are not necessarily to scale. In certain instances, details which are not necessary for an understanding of the present invention or which render other details difficult to perceive may have been omitted.

### DETAILED DESCRIPTION

Referring now, with more particularity, to the drawings, it should be noted that the disclosed invention is disposed to embodiments in various sizes, shapes, and forms, including a variety of morphological modifications to substrates, which substrates are made from of a variety of materials, a variety of scatterers, and a variety of tissue mimicking mediums in which a substrate is suspended. Therefore, the embodiments described herein are provided with the understanding that the present disclosure is intended as illustrative and is not intended to limit the invention to the embodiments described herein.

The present invention relates to systems, including methods and means, for testing and measuring the performance of ultrasonic imaging systems, also known as echography systems. The means include phantoms comprising substrates having morphologically modified surfaces on which scatterers are positioned, which scatterers in combination with the modified surface morphology provide for pulsed acoustical energy echoes exhibiting the high resolution required for the performance of the ultrasonic imaging system to be assessed using, for example, the modulation transfer function. The methods and means as taught herein accomplish this by providing for the reduction or elimination of destructive interference of pulsed acoustical waves, thus increasing the field magnitude of the echoes.

To explain how to make and use the various embodiments of this invention, a qualitative and quantitative examination and analysis of the physical phenomena involved when a transducer transmits a pulsed acoustical signal and, in turn, receives echoes of the acoustical signal from scattering particles (targets) positioned on or in a substrate surface. The pulsed acoustical signals have a resolution fine enough to ensure the sub-resolvability of the echoes where the scatterers are positioned to form a definable region for the testing of an imaging system. As mentioned in the Introduction section above, In order to test and measure the relationship between a sample and the resulting image, the ultrasound industry depends on the modulation transfer function (MTF), which is a mathematical procedure that is known to provide assessments of aliasing, spatial frequency response, and resolution limits for the evaluation of imaging systems generally. However, such assessments have not been possible with conventional ultrasound phantoms because to date these phantoms have not produced the detailed, high resolution patterns required for accurate evaluation of MTF and other imaging science criteria which represent the performance of the imaging system.

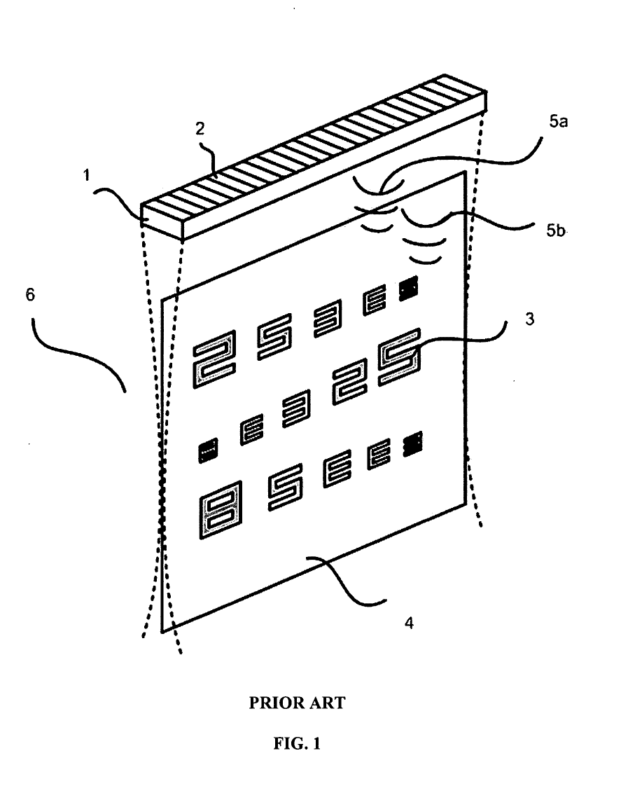

Turning now to the drawings for a diagrammatic view of a presently known ultrasound testing system, FIG. 1 illustrates transducer 1 comprising a plurality of discrete transducer elements 2 that emit pulses of ultrasonic wave energy 5a. The pulsed ultrasonic waves are reflected as acoustical echoes 5b from a variety of patterns of scatterers 3 on thin-film substrate 4. Thin-film substrate 4 is usually embedded in tissue mimicking material 6 that exhibits known acoustical properties and values of attenuation. The ultrasonic waves are transmitted from the transducer and some are reflected back to the transducer, primarily in an axial direction. A lateral repetition of this process produces a scan and provides signals that are subsequently processed by an imaging system that then outputs an image on the screen.

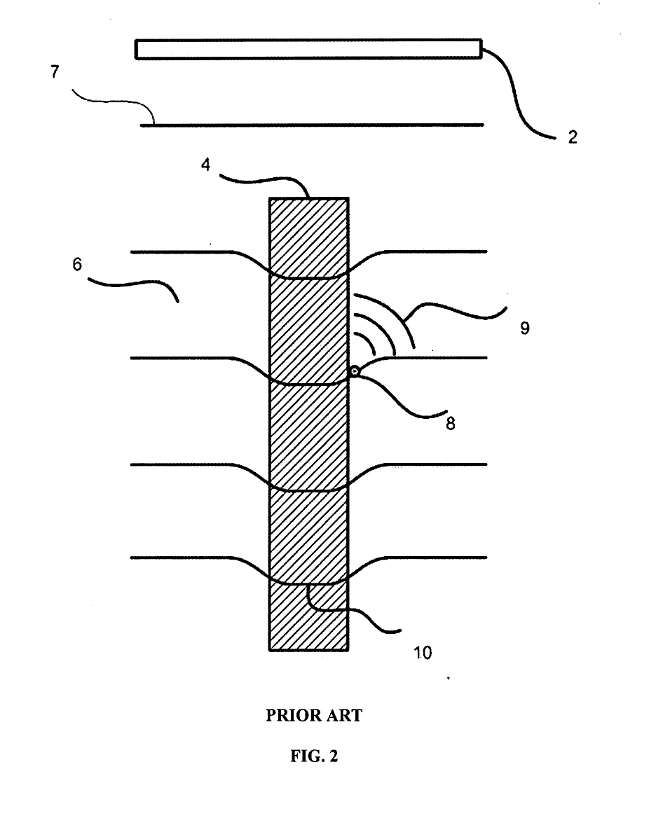

FIG. 2, a diagrammatic side view, illustrates a similar presently known phantom comprising a transducer and a thin-film substrate that is submerged in a tissue mimicking medium to demonstrate how the shape of wave front 7, which is generated by transducer element 2 and travels through tissue mimicking medium 6 is altered by its interaction with thin-film substrate 4. The acoustical energy pulsed from transducer 2 is emitted essentially as a planar wave front. The acoustical properties of planar film 4, however, deform planar wave 7 producing deformed wave front 10. The amount of deformation of wave front 7 is determined by how much the acoustical properties of thin-film substrate 4 deviate from the acoustical properties of the medium in which the thin-film is submerged. The greater the difference between the acoustical properties of the tissue mimicking medium and the thin-film substrate, the more the wave front will be deformed. Moreover, the magnitude of wave front deformation will determine to what degree echoes 9 will be deflected away from transducer element 2 by scatterer 8, resulting in the generation of weak echoes.

Given the detrimental effects resulting from wave deformation, it is easy to appreciate the importance of preventing the wave front from being deformed. As wave deformation is directly related to the magnitude of the difference in the acoustic properties of the thin-film substrate and the tissue mimicking medium, it is essential to keep the acoustical properties of the thin-film and the tissue mimicking medium as matched as possible. However, because of the many acoustical properties that must be considered, in addition to the speed of sound, it is difficult, if not impossible to identify substrates that exhibit acoustical properties exactly matching the tissue-mimicking material of interest. Thus, the choice of materials from which to make thin-film substrates is limited and, heretofore, has been mostly confined to metal, plastic, or rubber. Although some plastic or rubber sheets can be found having a speed of sound of around 1600 m/s (tissue-mimicking materials usually have a speed of sound of 1540 m/s), these flexible materials are not able to maintain planar surfaces.

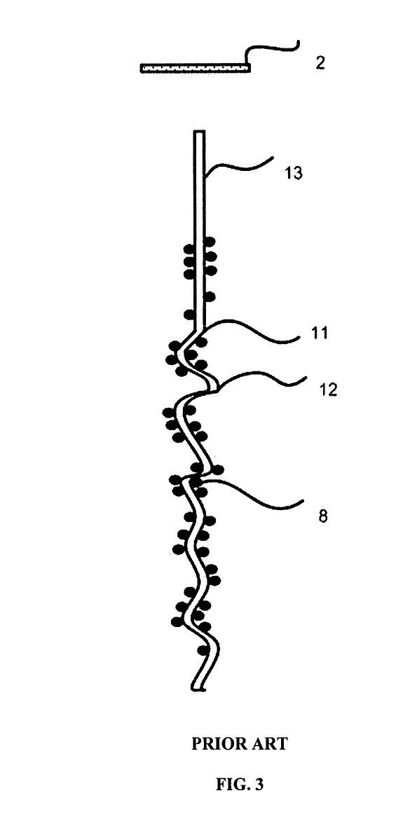

FIG. 3, a diagrammatic side plan view of a previously known transducer/substrate phantom system, depicts transducer element 2 and test targets 8 on non-planar substrate 13 exhibiting bends 11 and ripples 12. One consequence of having substrate that contains bends or ripples is that echoes scattered from some scatterers 8 can not be scanned by transducer 2. Additionally, images from a substrate that has bend or ripples contain artifacts that introduce another impediment to the analysis of the echoes by the modulation transfer function technique.

More problems are encountered when test target patterns are fixed onto a thin-film substrate by xerography, printing, or deposition techniques, because the sound waves that are reflected by such scatterers result in producing weak echoes that require a large amplification which contributes to a loss of resolution. Additionally, when substrates patterned using xerography, printing, or deposition techniques are immersed in an attenuating tissue mimicking medium, the weak echoes are easily overwhelmed, making image capture difficult, if not impossible.

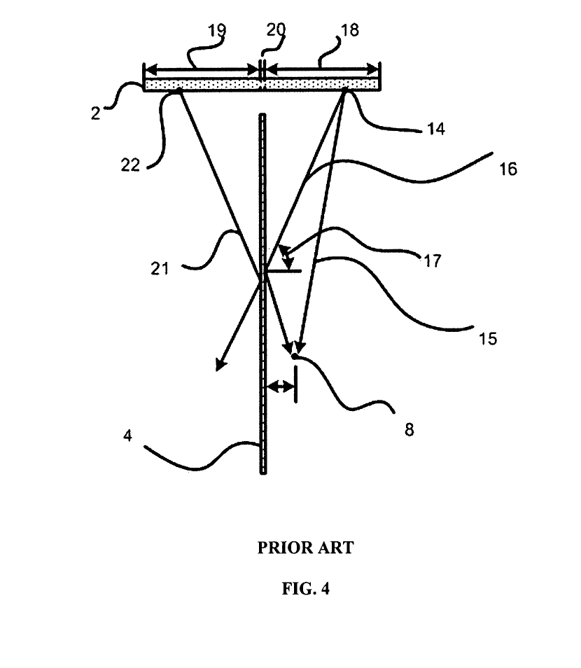

FIG. 4, a diagrammatic side view plan of a known transducer/thin-film phantom, depicts transducer element 2, thin-film substrate 4, and point scatterer 8. The dimensions of transducer elements, such as element 2, typically depend on the manufacturer, as well as, on the application and may, for example, have sub-millimeter lateral dimensions and be around 10 mm in height. Each transducer point, as exemplified by point 14 of transducer element 2, emits acoustical energy in the form of sound waves. Ideally, all of the energy of the sound waves emitted interacts with a scatterer, such as scatterer 8, to produce “echo” sound waves that return to an element. If the surface of substrate 4 is planar, there will be only one reflection point on the thin-film substrate from which a sound wave may be deflected to interact with a scatterer, such as test target scatterer 8. A given emitted sound wave may travel to a scatterer, such as 8, along either direct path 15 or reflected path, 16. The field magnitude (i.e., the strength or the amplitude) of the pulsed sound waves is the summation of direct wave 15 and deflected wave 16 as illustrated in FIG. 4 and the field intensity generated by the transducer, in turn determines, in large part, the strength of scattered echo signal that is received by the transducer.

Transducer element 2 as shown in FIG. 4 may be seen as being divided into three sections of elements, section 18 located on the same side of the substrate as scatterer 8, section 19 on the side opposite to that where scatterer 8 is located, and section 20 which lies directly above the substrate, as depicted in FIG. 4. Waves generated by transducer element points in 18 will reach target 8 following paths 15 and 16. Path 16 however, impinging on a substrate with a large incidence angle (17 in FIG. 4) would be reflected off the substrate 4, with a reflection coefficient, as basic acoustics theory shows, close to −1, i.e., a phase change of close to 180 degrees. On the other hand, the waves from the transducer elements section 19 and 20 are blocked from reaching the target 8 as illustrated by a path 21 in FIG. 4. Therefore, the resultant field intensity at the location of the scatterer 8 would be the sum of waves following path 15 and 16 of FIG. 4, and it would be small due to the interference between two waves following path 15 and 16 respectively. Thus, the waves transmitted from transducer elements of section 18 will generate the final echo image. However, if substrate 4 has patterns of scatterers 8 on both its sides, then both the transducer element areas 18 and 19 will generate the final echo image.

Total reflection of acoustic waves from the boundary between two substances takes place only when two conditions are met: (1) a wave is traveling from a substance of lower acoustical velocity to a substance of a higher acoustical velocity, and (2) when the angle of incidence of the wave on the boundary is greater than the critical angle. Each sound wave that impinges on the substrate does so at some angle. This angle is referred to as an “angle of incidence” (see angle 17 of FIG. 4). The critical angle is the greatest angle of incidence of a sound wave impinging on a substrate at which refraction can occur (note: refraction is the deflection or bending of an impinging sound wave from its path of travel as the sound wave passes through the boundary formed by the contact of one medium of one sound velocity into another medium having a different sound velocity). As stated above, if the angle of incidence of a sound wave on a substrate exceeds the critical angle and refraction cannot occur, total reflection occurs. For example, if medium in which the substrate is immersed has a speed of sound of 1540 m/s and the substrate has a speed of sound of 1600 m/s, the critical angle would be calculated to be about 74.26°, and consequently, any sound wave impinging on the substrate with incidence angle larger than about 74.26° will be totally reflected. Given a transducer element 5 mm from the center of the transducer, a scatterer related to the substrate located 3 cm from the transducer surface (in the axial direction of the substrate) and 0.2 mm from the substrate, the sound wave will impinge on the scatterer at an incidence angle of about 80.17° providing for a total reflection of the wave from the scatterer.

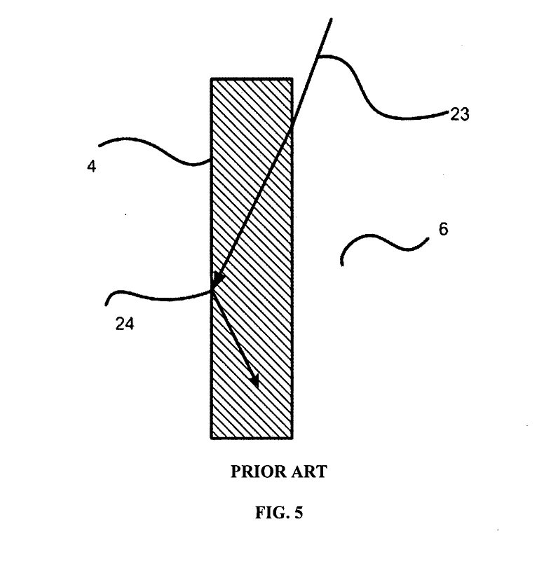

When energy waves cross a boundary between materials with different acoustic impedance, the waves will be partially refracted at the boundary surface, and partially reflected depending on the critical angle and the angle of incidence as shown in FIG. 5. As discussed above, when the angle of incidence is greater than the critical angle, reflection may occur, which in this case would be internal reflection and if the angle of incidence is less than the critical angle, the waves may be refracted. If a substrate has a speed of sound lower than its surrounding medium, as is depicted in FIG. 5, sound wave 23 will transmit into thin-film substrate 4. However, when the transmitted wave hits the other side of the substrate, the wave will be totally reflected back into the substrate if the incidence angle is greater than the critical, because now the wave will be traveling from a medium of lower acoustical velocity (the substrate) into a medium of a higher acoustical velocity (the medium).

As briefly mentioned above, field intensity is the sum of the direct waves and corresponding reflected waves where the direct waves and the reflected waves interact. The interaction, in this case, is destructive interference. The closer the phase shift of the reflected wave is to an 180° phase shift, the greater the reflected wave will destructively interfere with a direct wave. This results in the value of the field intensity at the location of the scatterer being relatively small because the phase of the reflected wave will be close to 180° out of phase relative to the direct wave, thereby tending to cancel each other. This can happen when wave reflection occurs at an incidence angle larger than the critical angle and close to 90°. It is the acoustical characteristics of the thin-film substrate and surrounding medium, together with the incidence angle of the sound wave that determines the reflection coefficient. Ideally, these problems do not occur if the substrate has acoustical properties exactly matching those of the tissue mimicking medium. Finding that substrate material, however, is not practical. This is why it is difficult to get strong echoes from targets made with printers or xerographic machines.

Although, as discussed above, the echogenicity of the scatterers depends on many factors, including scatterer particle size measured as cross-sectional area of the particle, acoustic properties of the scatterer, frequency of the sound waves, and the incoming field intensity, it is clear that the incoming wave intensity is a major influence on the strength of the echoes and, thus, on the sensitivity of the resulting image.

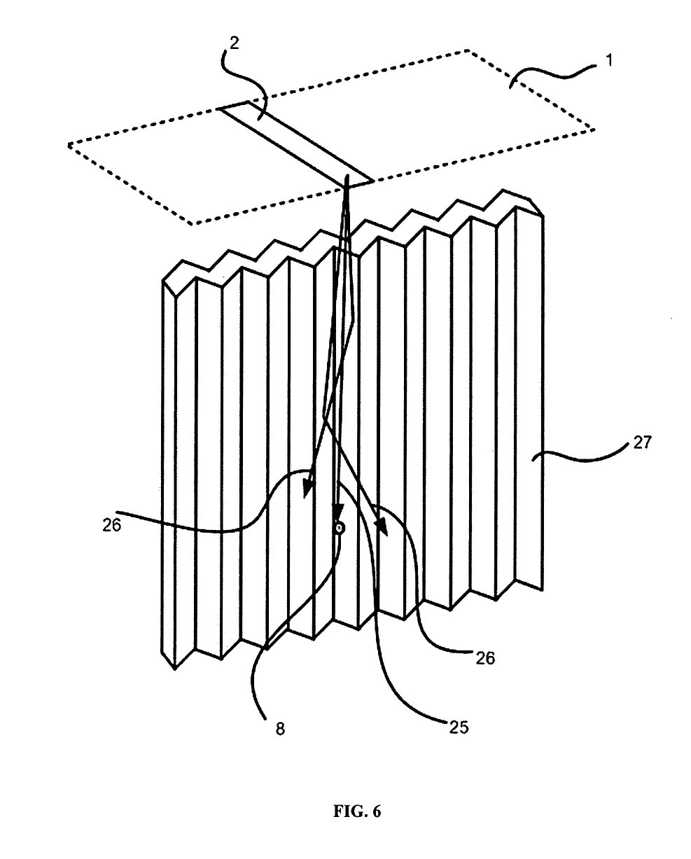

The present invention solves the problem of destructive interference between the emitted wave and the reflected wave near the surface of the substrate by positioning test target scatterers on a reflecting surface where the reflecting surface is one surface of a groove in a grooved substrate. For example, FIG. 6 illustrates element 2 of transducer 1 pulsing acoustical waves to a planar reflecting surface of one groove in grooved substrate 27 according to the principles of the present invention. In this example, a cross-section of each groove of the grooved substrate may be described as triangular and where the third side of the groove, represented by the base of the triangle, is open. It is the angle of the angled face of the triangle groove surface that provide for reducing, or even in some cases eliminating, destructive interference. This principle works with various applications by adjusting the angle of the surfaces of the groove and the spacing between each groove to meet the acoustical requirements of each application. As depicted in FIG. 6, reflected waves 26 each reflected from an inclined surface of a groove, cannot interact (i.e., destructively interfere) with direct wave 25, which is the only wave of the three waves able to interact with target 8. Thus, the echo wave is generated mostly by direct wave 37. Because the destructive interference is depressed, there is little reduction of the field strength of direct wave 25, and thus, the echo wave each has a greater field magnitude than it would if destructive interference had occurred.

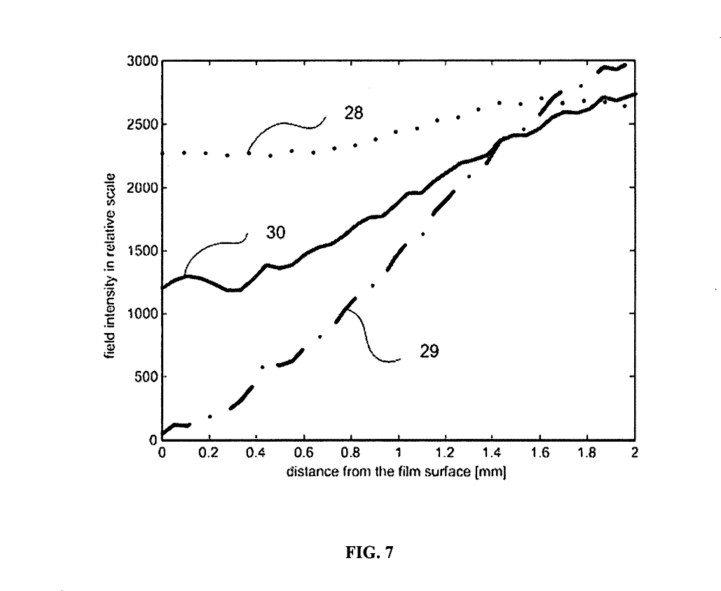

FIG. 7 shows three curves, each representing the field intensity in a relative scale at field points 5 cm from the transducer (axial distance) as a function of the distance (given in millimeters) from the surface of the thin-film substrate. Curve 28 depicts the field strength with no substrate present, thus there are no reflections and, therefore, only direct waves from all the parts of transducer add up to form a sound field. Curve 29, on the other hand, depicts the field strength with a flat surface substrate. The field of curve 29 shows weak field values close to the substrate, which can be explained, from the above explanation, that destructive interference between the direct waves and reflected waves is the main reason. Finally, Curve 30 illustrates the field strength of a grooved substrate. It is clearly noted that a morphologically modified reflective surface, such as a surface of a groove in a grooved substrate, where the reflecting surface is at a predetermined angle to the direction of propagation of the pulsed acoustic wave provides enhanced field strength compared to planar rigid or flexible thin-film substrates where the planar surface is parallel to the direction of the propagation of the pulsed acoustic wave. It is clear that the improvement comes from the grooved, angled surface steering reflected waves away from the sound wave that interacts with the scatterer, thus preventing the destructive interference between the direct waves and the reflected waves.

Further consideration and reasoning reveals additional advantages provided by the present invention. Another benefit of this invention is apparent when we think of echoes traveling from the target to the transducer. Presently available targets typically consist of a group of scatterers forming predetermined set patterns. The echoes from each scatterer will undergo multiple scattering among the scatterers and also between scatterers and the substrate. Conversely, the targets of the present invention may be randomly positioned on a reflecting surface and are individual entities. The scattering targets of this invention are disposed at a predetermined distance from a reflecting surface of a groove. There are many known means for attaching a scatterer to a surface and at different distance from the surface, thus there is no need to discuss these in any detail here. Additionally, in phantoms that are presently available, an incoming pulsed wave generates a form of wave propagating on the surface of a substrate that gives rise to a noise-like background in the image. As a result, the background of the image becomes bright resulting in low contrast between the pattern and the background. With this invention, however, those artifacts from the undesired echoes are steered away from the transducer thereby the background will remain dark and contrast will be much improved.

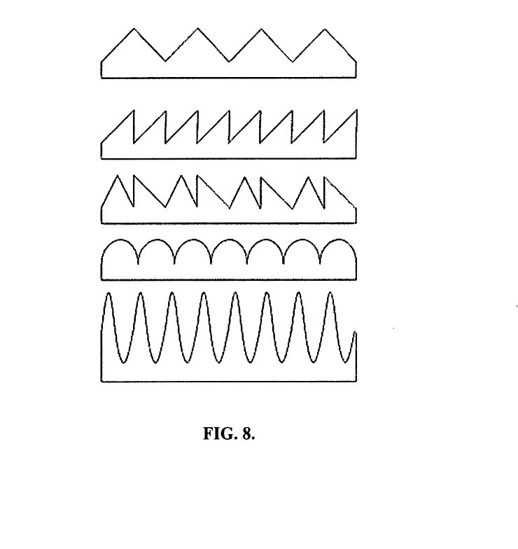

The surface modification of a substrate is not limited to the accordion pleated shape seen in FIG. 6. The morphological modifications of a substrate surface can take many forms. Several variations of groove shapes are illustrated in FIG. 8. These include, but are not limited to, triangular, circular, and sinusoidal shapes. The adoption of a specific shape depends on the applications and configuration parameters that include, but are not limited to, the geometric locations and dimensions of each part as well as acoustical parameters of each participating part. A specific groove shape will work as long as the design encompasses the key goal of this invention, that is, to block or steer away destructively interfering reflected waves.

Thus it has been shown how the present invention has developed test phantoms that provide high-resolution test objects for the testing and calibration of ultrasonic imaging systems. The grooved substrate surfaces described are shown to increase the echo field intensity.

The foregoing description, for purposes of explanation, uses specific and defined nomenclature to provide a thorough understanding of the invention. However, it will be apparent to one skilled in the art that the specific details are not required in order to practice the invention. Thus, the foregoing description of the specific embodiment is presented for purposes of illustration and description and is not intended to be exhaustive or to limit the invention to the precise form disclosed. Those skilled in the art will recognize that many changes may be made to the features, embodiments, and methods of making the embodiments of the invention described herein without departing from the spirit and scope of the invention. Furthermore, the present invention is not limited to the described methods, embodiments, features or combinations of features but include all the variation, methods, modifications, and combinations of features within the scope of the appended claims. The invention is limited only by the claims.

What is claimed is:

1. A phantom for testing the performance of acoustical imaging systems, comprising:
at least one substrate having at least one grooved surface, said grooved surface comprising a set of substantially parallel grooves;
at least one of said grooves having at least one reflecting surface, said reflecting surfaces providing for directionally controlled reflection of acoustical waves impinging on said reflecting surfaces providing for reducing destructive interference between pulsed acoustical waves impinging on said reflecting surface and pulsed acoustical non-impinging waves.

2. The phantom, as recited in claim 1, further comprising wherein at least one of said grooves comprises at least two reflecting surfaces.

3. The phantom, as recited in claim 1, further comprising wherein at least one of said grooves comprises at least one planar reflecting surface or at least one curved surface having an infinite number of reflecting surfaces.

4. The phantom, as recited in claim 1, further comprising at least one test target scatterer disposed on at least one of said reflecting surfaces.

5. The phantom, as recited in claim 1, further comprising wherein said grooves are oriented substantially parallel to a direction of acoustical wave propagation.

6. The phantom, as recited in claim 1, further comprising wherein said grooves are oriented at an angle to the direction of acoustical wave propagation.

7. The phantom, as recited in claim 1, further comprising wherein said substrate comprises a film or a sheet or a plate.

8. The phantom, as recited in claim 7, further comprising, wherein said substrate is made from a material selected from a group consisting of a plastic, a metal, a glass, a ceramic, a rubber, and a composite material.

9. The phantom, as recited in claim 1, further comprising, wherein said substrate is embedded in a wave propagating medium.

10. The phantom, as recited in claim 1, further comprising, wherein said substrate comprises two grooved surfaces.

11. A substrate for testing the performance of acoustical imaging systems, comprising:
a substrate having at least one grooved surface, said grooved surface comprising a set of substantially parallel grooves;
at least one of said grooves having at least one reflecting surface, said reflecting surface providing for directionally controlled reflection of acoustical waves impinging on said reflecting surface providing for reducing destructive interference of pulsed acoustical waves impinging on said reflecting surface and non-impinging pulsed acoustical waves.

12. The substrate, as recited in claim 11, further comprising wherein said at least one of said grooves comprises at least two reflecting surfaces.

13. The substrate, as recited in claim 11, further comprising wherein said at least one of said grooves comprises at least one planar reflecting surface or at least one curved surface having an infinite number of reflecting surfaces.

14. The substrate, as recited in claim 11, further comprising at least one test target scatterer disposed on at least one of said reflecting surfaces.

15. The substrate, as recited in claim 11, further comprising wherein said grooves are oriented substantially parallel to a direction of acoustical wave propagation.

16. The substrate, as recited in claim 11, further comprising wherein said grooves are oriented at an angle to the direction of acoustical wave propagation.

17. The substrate, as recited in claim 11, further comprising, wherein said substrate comprises a film or a sheet or a plate.

18. The substrate, as recited in claim 17, further comprising, wherein said substrate is made from a material selected from a group consisting of a plastic, a metal, a glass, a ceramic, a rubber, and a composite material.

19. The substrate, as recited in claim 11, further comprising, wherein said substrate is embedded in a wave propagating medium.

20. A method for testing the performance of acoustical imaging systems, comprising:
providing at least one substrate having at least one grooved surface comprising a set of substantially parallel grooves;
providing for at least one of said grooves to comprise at least one reflecting surface,
providing at least one test target scatterer disposed on at least one of said reflecting surfaces.
embedding said substrate in a wave propagating medium,
pulsing energy in the form of acoustic waves through said wave propagating medium toward said test target scatterers, said test target scatterers providing for directionally controlled scattering of pulsed acoustic waves impinging on said scatterers providing for reduced destructive interference of pulsed acoustic waves impinging on said reflecting surface and non-impinging pulsed acoustic waves providing for an increased field magnitude of echoed waves.
